(19) United States
(12) Patent Application Publication
(10) Pub. No.: US 2025/0257942 A1
(43) Pub. Date: Aug. 14, 2025

(54) Cryogenic Carbon Capture System and Method with Integrated Liquid Natural Gas Vaporizer

(71) Applicant: Chart Energy & Chemicals, Inc., Ball Ground, GA (US)

(72) Inventors: Ravikumar Vipperla, Katy, TX (US); Christopher Hoeger, Orem, UT (US); Larry Baxter, Orem, UT (US)

(21) Appl. No.: 19/053,344

(22) Filed: Feb. 13, 2025

Related U.S. Application Data
(60) Provisional application No. 63/553,399, filed on Feb. 14, 2024.

(51) Int. Cl. F25J 3/06; B01D 53/00

(52) U.S. Cl. CPC F25J 3/067; B01D 53/002; B01D 2257/504; B01D 2258/0283; F25J 2205/20; F25J 2210/70; F25J 2220/84; F25J 2260/02

(57) ABSTRACT

A desublimating heat exchanger receives a cooled process gas stream from a pre-cool heat exchanger and includes a clean gas outlet, a contact liquid inlet and a slurry outlet. A contact liquid heat exchanger communicates with the contact liquid inlet of the desublimation heat exchanger and warms a liquid natural gas stream to provide cooling within the contact liquid heat exchanger. The desublimating heat exchanger contacts the cooled process gas stream with the cooled contact liquid so that carbon dioxide is absorbed within the contact liquid whereby a carbon dioxide laden slurry stream and a carbon dioxide depleted clean process gas stream are formed. The clean process gas stream passes through the clean gas outlet to the pre-cool heat exchanger and the slurry stream passes through the slurry outlet. The pre-cool heat exchanger warms the clean process gas stream to provide cooling for the process gas stream. A solid separation device communicates with the contact inlet of the desublimating heat exchanger and separates the carbon dioxide laden slurry stream from the desublimating heat exchanger into a condensed carbon dioxide stream and a contact liquid stream.

### CLAIM OF PRIORITY

This application claims the benefit of U.S. Provisional Application No. 63/553,399, filed Feb. 14, 2024, the contents of which are hereby incorporated by reference.

### FIELD OF THE DISCLOSURE

The present disclosure relates generally to systems and methods for purifying gases and, more particularly, to a system and method that integrates cryogenic carbon capture with liquid natural gas vaporization.

### BACKGROUND

Gas purification of carrier or feed gases has been an important process in industry for many years. An example is the processing of combustion flue gases. Combustion flue gas consists of the exhaust gas from a fireplace, oven, furnace, boiler, steam generator, or other combustor. The combustion fuel sources include coal, natural gas, liquid hydrocarbons, black liquor and biomass. Combustion flue gas varies greatly in composition depending on the method of combustion and the source of fuel. Combustion using air leads to most of the flue gas consisting of nitrogen. The non-nitrogen flue gas consists of mostly carbon dioxide (or CO₂), water, and unconsumed oxygen. Small amounts of carbon monoxide, nitrogen oxides, sulfur dioxide, and trace amounts of hundreds of other chemicals are present, depending on the source. Entrained dust and soot will also be present in most combustion flue gas streams.

The separation of carbon dioxide from light gases such as nitrogen is called carbon capture and is important for reducing CO₂ emissions and their associated environmental impacts. It is commonly believed that this CO₂ represents a significant factor in increasing the greenhouse effect and global warming. Therefore, there is a clear need for efficient methods of capturing CO₂ from flue gases to produce a concentrated stream of CO₂ that can readily be transported to a safe storage site or to a further application.

Natural gas is often liquefied for storage and transport because the liquefaction reduces the volume of the fluid and lowers storage and handling equipment costs. After the resulting liquid natural gas (LNG) reaches its use point, however, it typically must be vaporized for use as natural gas.

It has been recognized in the prior art that the heat required for vaporizing LNG may be provided by cryogenic carbon capture systems. More specifically, with reference to FIG. 1, LNG from a storage tank 10 may be provided, either directly or by pump 12, to a cryogenic carbon capture system 14. The cryogenic carbon capture system 14 receives flue gas 16, which contains CO₂ and light gases such as nitrogen, from a combustion source. The cryogenic carbon capture system 14 uses the refrigeration provided by the LNG to separate the flue gas 16 into a CO₂ stream 18 and a light gases stream 20. The resulting vaporized natural gas exits the cryogenic carbon capture system 14 as stream 22. If stream 22 is not fully vaporized, additional heating may be provided by a heat exchanger 24. Furthermore, or alternatively, the natural gas fluid stream may be expanded via expansion device 26 to reduce the pressure of the stream. A system that integrates cryogenic carbon capture and LNG vaporization is disclosed in commonly owned U.S. Pat. No. 9,410,736 to Baxter, the contents of which are hereby incorporated by reference.

New technologies that integrate cryogenic carbon capture with LNG vaporization to provide efficiency and/or cost advantages are desirable.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a system for separating carbon dioxide from a process gas includes a pre-cool heat exchanger configured to receive and cool a process gas stream so that a cooled process gas stream is formed. A desublimating heat exchanger includes a process gas inlet configured to receive the cooled process gas stream from the pre-cool heat exchanger, a clean gas outlet, a contact liquid inlet and a slurry outlet. A contact liquid heat exchanger is in fluid communication with the contact liquid inlet of the desubimation heat exchanger and is configured to receive and warm a liquid natural gas stream to provide cooling within the contact liquid heat exchanger. The desublimating heat exchanger is configured to contact the cooled process gas stream received from the pre-cool heat exchanger with contact liquid cooled by the contact liquid heat exchanger so that carbon dioxide is absorbed within the contact liquid whereby a carbon dioxide laden slurry stream and a carbon dioxide depleted clean process gas stream are formed. The clean process gas stream directed through the clean gas outlet to the pre-cool heat exchanger and the slurry stream directed through the slurry outlet. The pre-cool heat exchanger is configured to warm the clean process gas stream to provide cooling for the process gas stream. A solid separation device is in fluid communication with the contact liquid inlet of the desublimation heat exchanger and is configured to receive the carbon dioxide laden slurry stream from the slurry outlet of the desublimating heat exchanger and to separate the slurry stream into a condensed carbon dioxide stream and a contact liquid stream.

In another aspect, a system for separating carbon dioxide from a process gas includes a pre-cool heat exchanger configured to receive and cool a process gas stream so that a cooled process gas stream is formed. A desublimating heat exchanger includes a process gas inlet configured to receive the cooled process gas stream from the pre-cool heat exchanger, a clean gas outlet, a contact liquid inlet and a slurry outlet. A solid separation device is configured to direct a contact liquid to the contact liquid inlet of the desublimating heat exchanger. The desublimating heat exchanger is configured to contact the cooled process gas stream received from the pre-cool heat exchanger with contact liquid from the solid separation device so that carbon dioxide is absorbed within the contact liquid whereby a carbon dioxide laden slurry stream and a carbon dioxide depleted clean process gas stream are formed. The clean process gas stream is directed through the clean gas outlet to the pre-cool heat exchanger and the slurry stream is directed through the slurry outlet to a contact liquid heat exchanger. The pre-cool heat exchanger is configured to warm the clean process gas stream to provide cooling for the process gas stream. The contact liquid heat exchanger is configured to receive and warm a liquid natural gas stream to cool the slurry stream. The contact liquid heat exchanger is also configured to direct the cooled slurry stream to the solid separation device. The solid separation device is configured to separate the carbon dioxide laden slurry stream into a condensed carbon dioxide stream and a contact liquid stream.

In another aspect, a method for separating carbon dioxide from a process gas includes the steps of: pre-cooling a process gas stream by warming a clean process gas stream so that a cooled process gas stream is formed; cooling a contact liquid by warming a liquid natural gas stream so that a cooled contact liquid stream is formed; contacting the cooled process gas stream with the cooled contact liquid stream so that carbon dioxide is absorbed within the contact liquid whereby a carbon dioxide laden slurry stream and a carbon dioxide depleted clean process gas stream are formed, where the clean process gas stream is warmed to cool the process gas stream, and separating the slurry stream into a condensed carbon dioxide stream and a contact liquid stream.

### BRIEF DESCRIPTION OF THE DRAWINGS

FIG. 1 is a simplified process flow diagram illustrating the primary components of a prior art cryogenic carbon capture system integrated with a liquid natural gas vaporization system.

FIG. 2 is a simplified process flow diagram illustrating the primary components of an embodiment of the system of the disclosure.

FIG. 3 is a simplified process flow diagram of the system of FIG. 2 with an additional heater for the LNG stream.

FIG. 4 is a simplified process flow diagram of the system of FIG. 3 where the contact liquid is routed through the additional heat exchanger.

FIG. 5 is a process flow diagram and schematic of an embodiment of the system of the disclosure.

FIG. 6 is a process flow diagram and schematic of an alternative embodiment of the system of the disclosure.

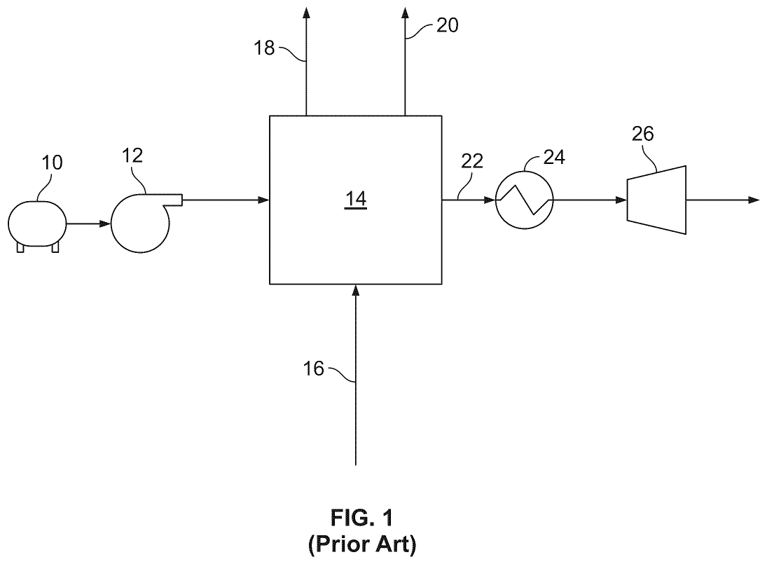

### DETAILED DESCRIPTION OF EMBODIMENTS

It should be noted herein that the lines, conduits, piping, passages and similar structures and the corresponding streams are sometimes both referred to by the same element number set out in the figures.

Also, as used herein, and as known in the art, a heat exchanger is that device or an area in the device wherein indirect heat exchange occurs between two or more streams at different temperatures, or between a stream and the environment. In addition, all heat exchangers referenced herein may be incorporated into one or more heat exchanger devices or may each be individual heat exchanger devices. As used herein, the terms “communication”, “communicating”, and the like generally refer to fluid communication unless otherwise specified. And although two fluids in communication may exchange heat upon mixing, such an exchange would not be considered to be the same as heat exchange in a heat exchanger, although such an exchange can take place in a heat exchanger.

As used herein, the terms, “high”, “middle”, “warm”, “cold” and the like are relative to comparable streams, as is customary in the art.

Any column or tower referenced in the following description may, as non-limiting examples only, be a spray tower, a packed column, and/or a trayed column.

Reference numerals that are introduced in the specification in association with a drawing figure may be repeated in one or more subsequent figures for shared elements or components without additional description in the specification in order to provide context for other features.

In the claims, letters are used to identify claimed steps (e.g. a., b. and c.). These letters are used to aid in referring to the method steps and are not intended to indicate the order in which the claimed steps are performed, unless and only to the extent that such order is specifically recited in the claims.

Embodiments of the process and method of the disclose separate a CO₂-containing process gas stream into a liquid-phase CO₂ stream of arbitrary purity (including beverage-grade CO₂) and a CO₂-depleted stream containing the remaining light gases. The light gases could include N₂, O₂, and Ar in the case of treating a flue gas stream, H₂, CO and possibly CH₄ in the case of treating a producer gas or syngas stream, and H₂ in the case of treating a hydrogen production stream.

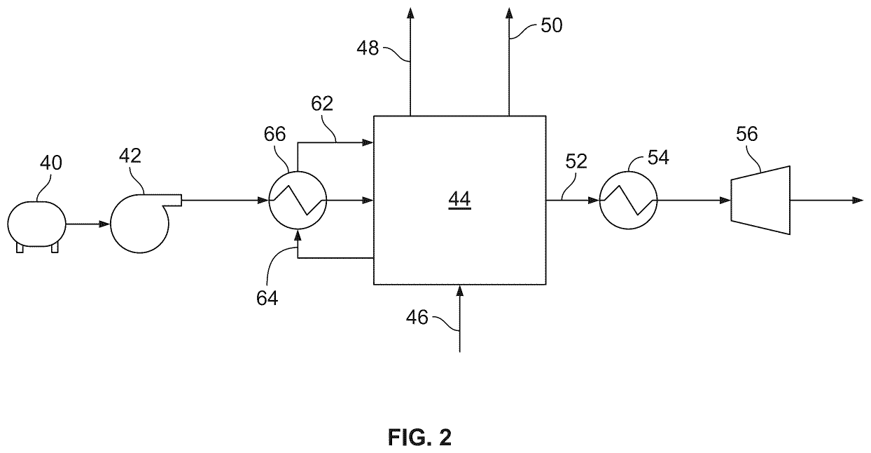

In an embodiment of the system and method of the disclosure illustrated in FIG. 2, a stream of LNG from a storage tank 40 may be provided, either directly or by pump 42, to a cryogenic carbon capture system 44. While a storage tank is illustrated for the LNG, the cryogenic capture system 44 may receive the LNG from another source or type of storage.

The cryogenic carbon capture system 44 receives flue gas 46, which contains CO₂ and light gases such as nitrogen, from a combustion source. As explained in greater detail below, the cryogenic carbon capture system 44 uses the refrigeration provided by the LNG to separate the flue gas 46 into a CO₂ stream 48 and a light gases stream 50. The resulting vaporized natural gas exits the cryogenic carbon capture system 44 as stream 52. If stream 52 is not fully vaporized, additional heating may be provided by a heat exchanger 54. Furthermore, or alternatively, a natural gas fluid stream may be expanded via expansion device 56 to reduce the pressure of the stream. As an example only, the expansion device 56 may be a turbine.

In the cryogenic carbon capture system 44 of FIG. 2, flue gas stream 46, after initial processing including cooling which may use the LNG, travels to a direct-contact desublimating heat exchanger where CO₂ is captured by further cooling using a cryogenic contacting liquid stream 62 to the temperature required to capture the design amount of CO₂ as a condensed phase in the contacting liquid. The required temperature depends on the amount of CO₂ in the process gas, the desired capture amount, and the type and initial CO₂ loading of the contact liquid and, as an example only, may be around −106° C. for 90% capture from a process gas stream containing 16% CO₂ and a typical hydrocarbon contact liquid. The gas-phase CO₂ of the flue gas stream 46 condenses in the contact liquid stream 62 as either an absorbed gas, a desublimated solid, or a combination of both, to form a slurry stream.

As examples only, the contact liquid 62 and 64 can be any fluid with a freezing point below the frost or dew point of the condensable vapors and that is non-volatile or has low volatility. The low volatility minimizes the amount of contact liquid that escapes the direct-contact desublimation heat exchanger, which minimizes environmental impacts and costs. Examples of suitable contact liquids include, but are not limited to methyl cyclopentane, methyl cyclohexane, a variety of fluorinated or chlorinated hydrocarbons, or any compound or solution that has low vapor pressure at the temperature of system operation, has a manageable viscosity, and has no materials incompatibilities or unmanageable health and safety issues, including mixtures of such compounds.

In the cryogenic carbon capture system 44 of FIG. 2, a light gas stream is separated from the slurry stream and exits the desublimating heat exchanger, and the cryogenic carbon capture system 44, as light gas stream 50. The CO₂ is separated from the slurry stream in a separation device, melted (if in the solid phase) and exits the cryogenic carbon capture system 44 as condensed CO₂ stream 48. The warmed contact liquid stream, after removal of the CO₂, exits the separation device of the cryogenic carbon capture system 44 as stream 64.

Further details of an example of the cryogenic carbon capture system 44 of FIG. 2 are disclosed in commonly assigned U.S. Pat. No. 8,764,885 to Baxter et al., the contents of which are hereby incorporated by reference. In addition, other details regarding the cryogenic carbon capture system 44 of FIG. 2 are provided in commonly owned U.S. Pat. No. 10,724,793 to Baxter, the contents of which are hereby incorporated by reference.

In accordance with the technology of the disclosure, warmed contact liquid stream 64 is directed to an indirect-contact heat exchanger 66 for cooling by the LNG stream from tank 40 to the temperature required to capture the design amount of CO₂.

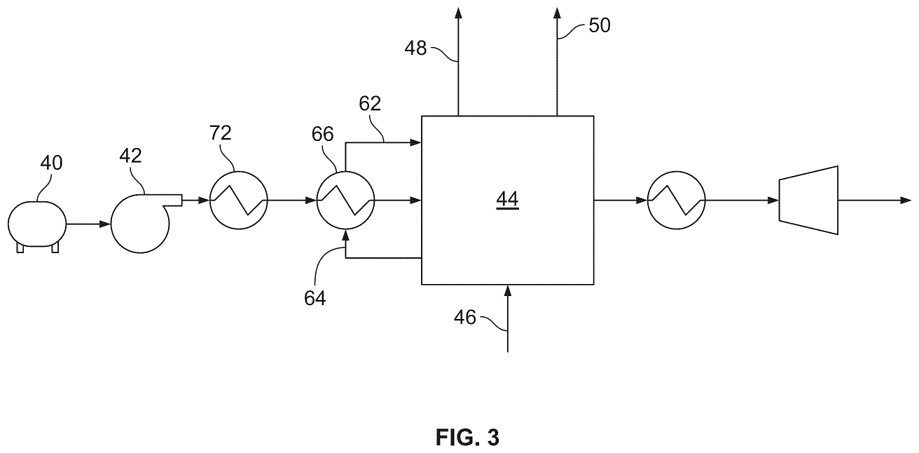

In the system of FIG. 3, an LNG heater 72 has been added to the system of FIG. 2. The LNG heater may be required to warm the LNG from tank 40 to prevent freezing of the contact liquid in the heat exchanger 66. As an example only, the temperature of the LNG exiting tank 40 may have a temperature of −160° C., while the contact liquid stream 64 may have a freezing temperature of −120° C. LNG heater 72 may warm the LNG to a temperature slightly above the freezing temperature of the contact liquid stream 64. The flow rate of the contact liquid through the heat exchanger 66 should also be maintained at a sufficient level to avoid freezing within the heat exchanger 66.

As examples only, LNG heater 72 may use ambient air to warm the LNG stream or it may be an electric heater.

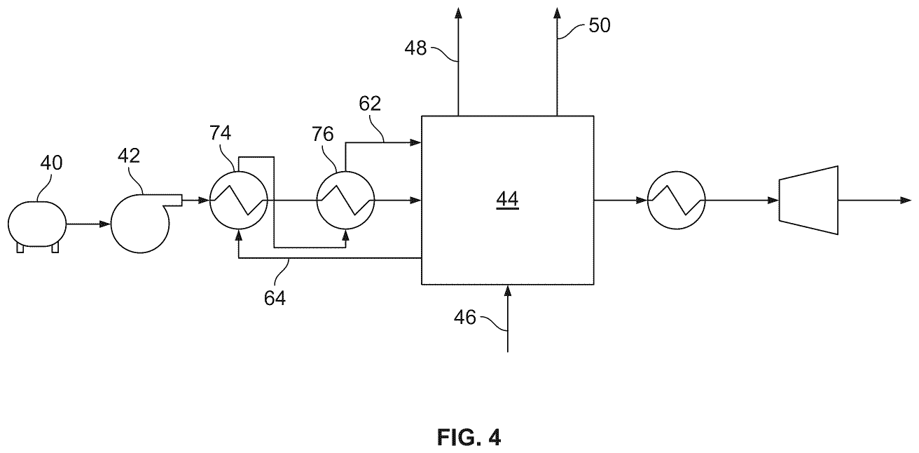

In the system of FIG. 4, the functionality of heat exchanger 66 of FIGS. 2 and 3 may be divided between first and second heat exchangers 74 and 76. More specifically, the warmed contact liquid stream 64 is directed to an indirect-contact heat exchangers 74 and 76 for cooling by the LNG stream from tank 40 to the temperature required to capture the design amount of CO₂. To avoid freezing of the contact liquid 64 in the colder heat exchanger 74, ceramic sleeves may be provided to insulate the contact liquid passages from the LNG. Alternatively, the ceramic insulation may be provided for the LNG passages of the heat exchanger 74 to reduce the heat transfer from the contact liquid stream.

In an alternative embodiment of the system of FIG. 4, an intermediate fluid may be directed through first and second heat exchangers 74 and 76 with the resulting cooled intermediate fluid used to cool the contact liquid used by the cryogenic carbon capture process 44 using an indirect-contact heat exchanger.

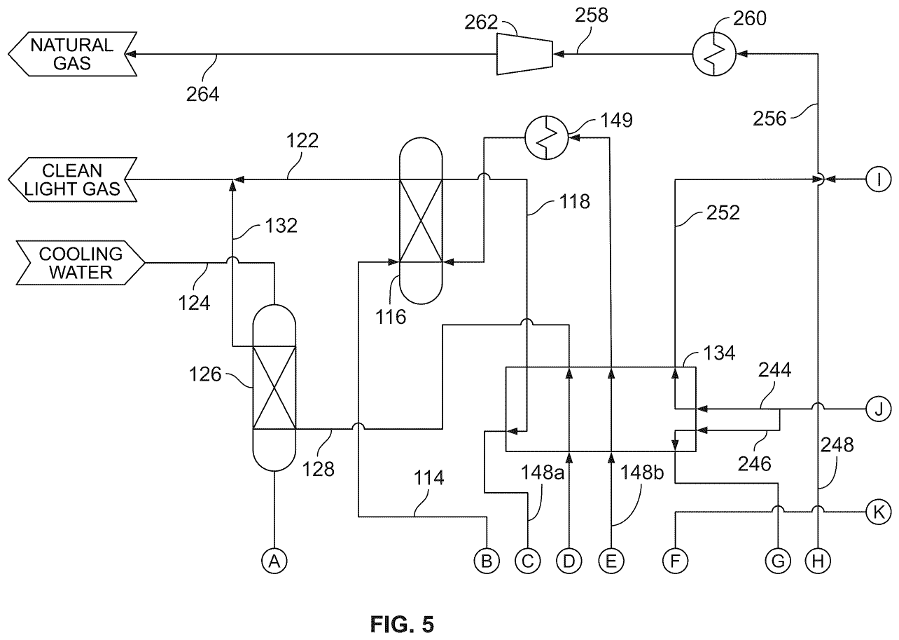

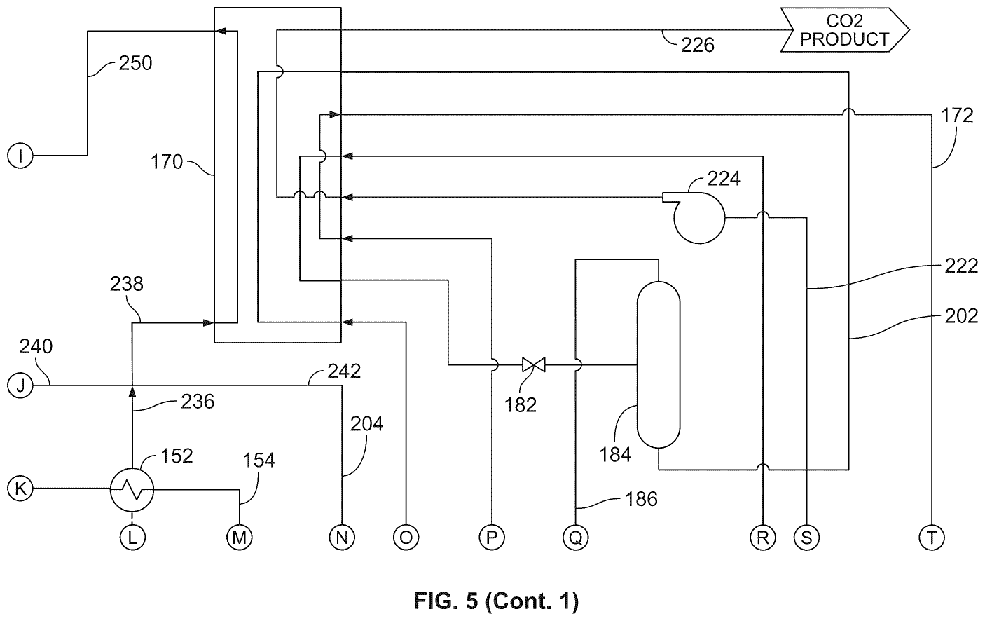

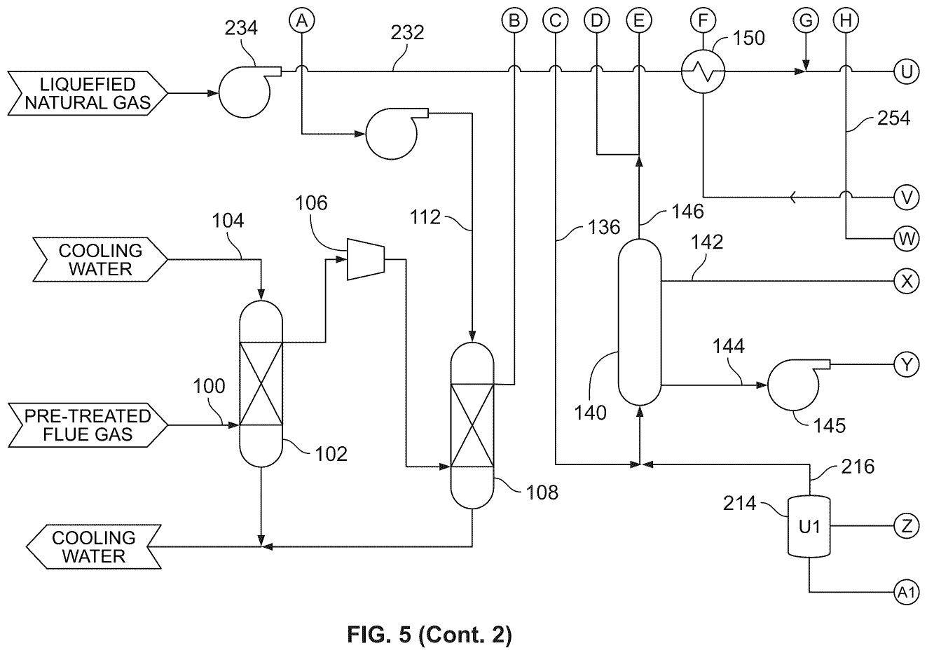

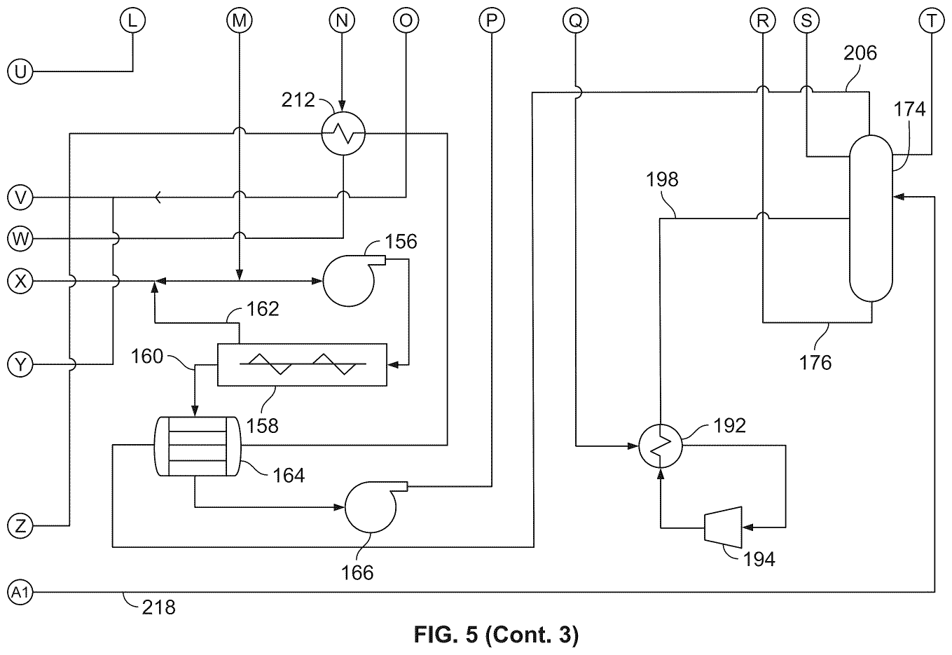

With reference to FIG. 5, which presents a more detailed view of an embodiment of the system and method of the disclosure, a pre-treated flue gas is directed as process gas 100 to a pre-cool heat exchanger such as cooling tower 102 which, as an example only, may be a direct contact cooling tower that uses a chilled water stream 104 to provide cooling. The pre-cool cooling tower 102 cools the process gas stream 100 to just above 0° C. (as an example only). The resulting cooled stream is directed to a blower 106, such as a compressor. After leaving the blower 106, the pressurized process gas stream travels through a second heat exchanger such as a second cooling tower 108, which provides cooling via water stream 112.

The cooled and pressurized process stream 114 exiting the second cooling tower 108 travels to a desiccant dryer 116, where moisture is recovered from the process gas with a resulting dried process gas stream exiting the dryer as stream 118. A CO₂-depleted “clean” light gas stream is also formed and exits the dryer as clean light gas stream 122.

Suitable desiccant dryers are well known in the art. As an example only, the desiccant dryer 116 may incorporate the technology disclosed in U.S. Patent Application Publication No. US 2019/0128604 (U.S. patent application Ser. No. 15/795,953) to Baxter et al, the contents of which are hereby incorporated by reference.

Cooling water for cooling towers 102 and 108 enters the system as stream 124 and is cooled in a heat exchanger such as cooling tower 126. Cooling within cooling tower 126 is provided by a cooled light gas stream 128, the provision of which will be explained below. A warmed clean light gas stream exits cooling tower 126 as stream 132, which joins the clean light gas stream 122 exiting the desiccant dryer 116, with the resulting combined stream exiting the system.

The dried process gas stream 118 exiting the desiccant dryer 116 is directed to a multi-stream pre-cool heat exchanger 134 where it is further cooled, preferably to near its frost point (typically −95 to −105° C.).

The resulting pre-cooled process stream 136 is directed to a direct-contact desublimating heat exchanger, such as cooling tower 140, where CO₂ is captured by further cooling the process gas stream, using a cryogenic contacting liquid stream 142, to the temperature required to capture the design amount of CO₂ as a condensed phase in the contacting liquid. The required temperature depends on the amount of CO₂ in the process gas, the desired capture amount, and the type and initial CO₂ loading of the contact liquid and, as an example only, typically is around −106° C. for 90% capture from a process gas stream containing 16% CO₂ and a typical hydrocarbon contact liquid. The gas-phase CO₂ of the further-cooled process gas stream condenses in the contact liquid stream 142 as either an absorbed gas, a desublimated solid, or a combination of both, to form slurry stream 144. All other species below their dew/frost points may also condense in this stage, which commonly includes most species less volatile than CO₂ including most pollutants and other contaminants (NO₂, SO₂, SO₃, Hg, VOCs, PCHs).

As noted previously, and as an example only, the direct-contact desublimating heat exchanger 140 may use technology disclosed in commonly assigned U.S. Pat. No. 8,764,885 to Baxter et al., the contents of which are hereby incorporated by reference.

A CO₂-depleted process gas stream 146 (i.e. “clean” flue gas) exits the top of the desublimating heat exchanger 140 and is split into streams 148a and 148b, both of which pass through pre-cool heat exchanger 134 and are warmed to provide cooling therein. Warmed clean light gas stream 148a exits the pre-cool heat exchanger 134 as clean light gas stream 128 and is directed to cooling water cooling tower 126 to provided refrigeration therein, as noted previously. Steam 148b, after warming in heat exchanger 134 is directed through regeneration gas heater 149 where it is further warmed and then directed to the desiccant dryer 116 for moisture removal.

The CO₂-laden slurry stream 144 is pumped via cryogenic pump 145 to contact liquid cooling heat exchangers 150 and 152 where it is cooled prior to exiting the second heat exchanger 152 as cooled slurry stream 154.

Cooled slurry stream 154 is pumped via slurry pump 156 to a screw press 158 or other solids separation device where the solid CO₂ is separated from the contact liquid so that solid CO₂ stream 160 and purified contact liquid stream 162 are formed. Purified contact liquid stream 162 may be combined with a portion of cooled slurry stream 154 and is directed to the direct-contact desublimating heat exchanger 140 as contact liquid stream 142.

Alternative solid separation devices including, but not limited to, filtration devices or cyclone separators, may be substituted for the screw press 158.

Solid CO₂ stream 160 is directed to a melter, such as indirect-contact heat exchanger 164, with the resulting CO₂ liquid stream being pumped by melter pump 166 to a multi-stream product heat exchanger 170, where it is cooled. The resulting cooled CO₂ liquid stream 172 is directed to CO₂ polishing column 174.

Additional contact liquid is removed from the CO₂ of stream 172 and exits the CO₂ polishing column 174 as contact liquid stream 176. Contact liquid stream 176 is cooled in product heat exchanger 170 with the resulting stream being expanded via expansion device 182. As an example only, the expansion device 182 may be Joule-Thompson (JT) valve. The expanded stream exits expansion device 182 and flows into contact liquid polishing column 184.

A carbon dioxide vapor stream 186 exits the top of the contact liquid polishing column 184 and, after passing through heat exchanger 192, is compressed in compressor 194. The compressed CO₂ stream exiting the compressor 194 is cooled in heat exchanger 192 (by stream 186) with the resulting cooled stream 196 being directed to CO₂ stream 198 being directed into CO₂ polishing column 174.

A contact liquid stream 202 exits the bottom of contact liquid polishing column 184 and is cooled in product heat exchanger 170 to form cooled contact liquid stream 204. Cooled contact liquid stream 204 joins the slurry stream exiting slurry pump 146 with the combined stream being directed to first and second heat exchangers 150 and 152 for cooling.

A CO₂ vapor stream 206 exits the top of the CO₂ polishing column 174 and travels to melter 164 to provide the heat necessary to melt the CO₂ solid stream 160 from screw press 158. The resulting cooled CO₂ stream is further cooled in LNG vaporizer heat exchanger 212 and then directed to flash drum 214. A resulting CO₂ vapor stream 216 exits the top of the flash drum 214 and is directed to the desublimating heat exchanger 140. A CO₂ liquid stream 218 exits the bottom of the flash drum 214 and is directed back to the CO₂ polishing column 174.

A CO₂ liquid product stream 222 exits CO₂ polishing column 174 and is directed, via pump 224 through product heat exchanger 170 for cooling. As a result, a cooled CO₂ liquid product stream 226 is formed and directed out of the system.

As will now be described, in accordance with an embodiment of the disclosure, cooling for the system of FIG. 5 is provided by a liquid natural gas (LNG) stream 232, which may be pumped via pump 234 or otherwise provided from a tank or other source. LNG stream 232 travels through heat exchangers 150 and 152 to provide cooling therein and form warmed LNG stream 236. A resulting vaporized (or partially vaporized) natural gas stream 236 exits heat exchanger 170.

After leaving heat exchanger 152, LNG stream 236 is split into LNG streams 238, 240 and 242.

LNG stream 238 travels through product heat exchanger 170 to provide cooling therein. A resulting vaporized (or partially vaporized) natural gas stream 250 exits heat exchanger 170.

LNG stream 240 splits into streams 244 and 246 which flow to pre-cool heat exchanger 134. Stream 246 is warmed in the pre-cool heat exchanger 134 and a resulting warmed LNG stream 248 exits the heat exchanger and joins the LNG stream exiting heat exchanger 150. LNG stream 244 is also warmed in the pre-cool heat exchanger 134 with the resulting warmed LNG stream 252 exiting the heat exchanger.

LNG stream 242 travels through heat exchanger 212 and provides cooling therein, with the resulting warmed stream 254 joining streams 250 and 252 to form combined stream 256. Combined stream 256 may be warmed via heater 260 if the stream still contains liquid or if a warmer natural gas stream is desired. Natural gas stream 258 may then flow out of the system directly or may first be expanded via expansion device 262 which, as an example only, may be a turbine.

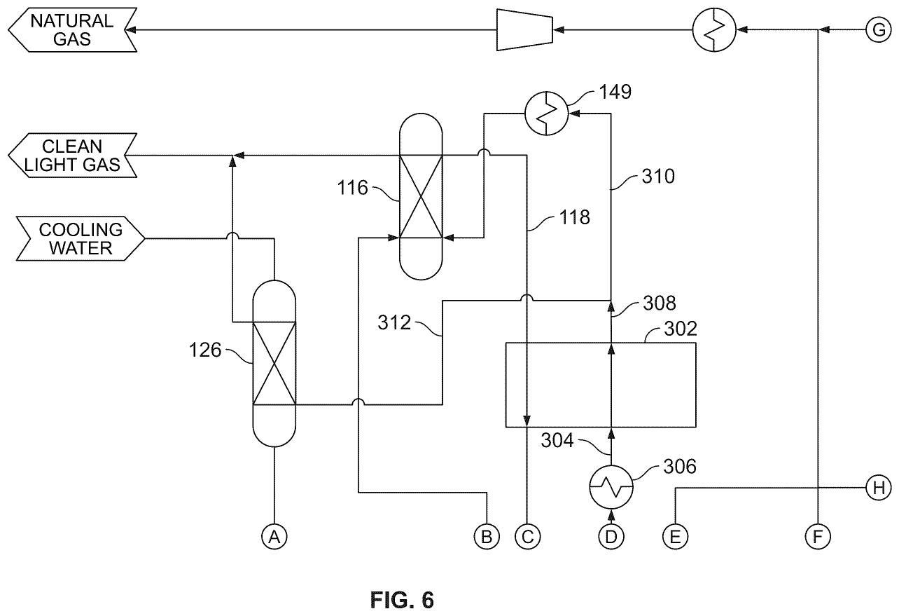

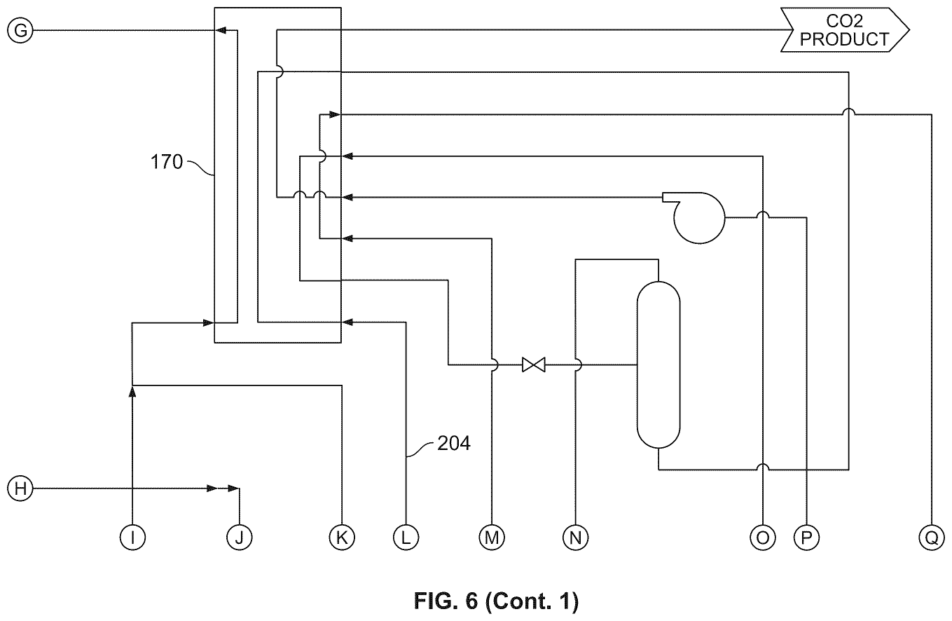

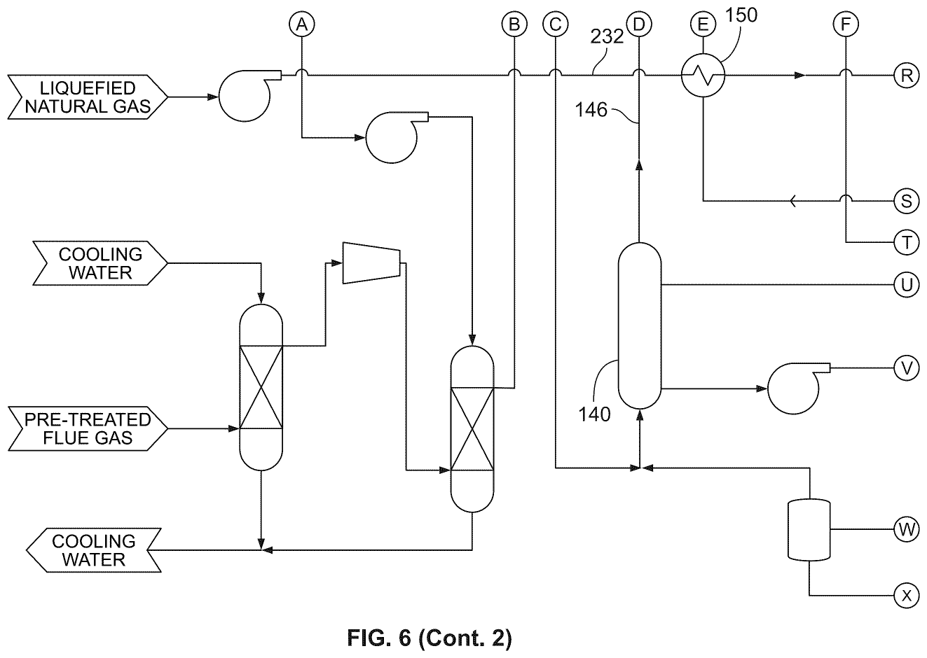

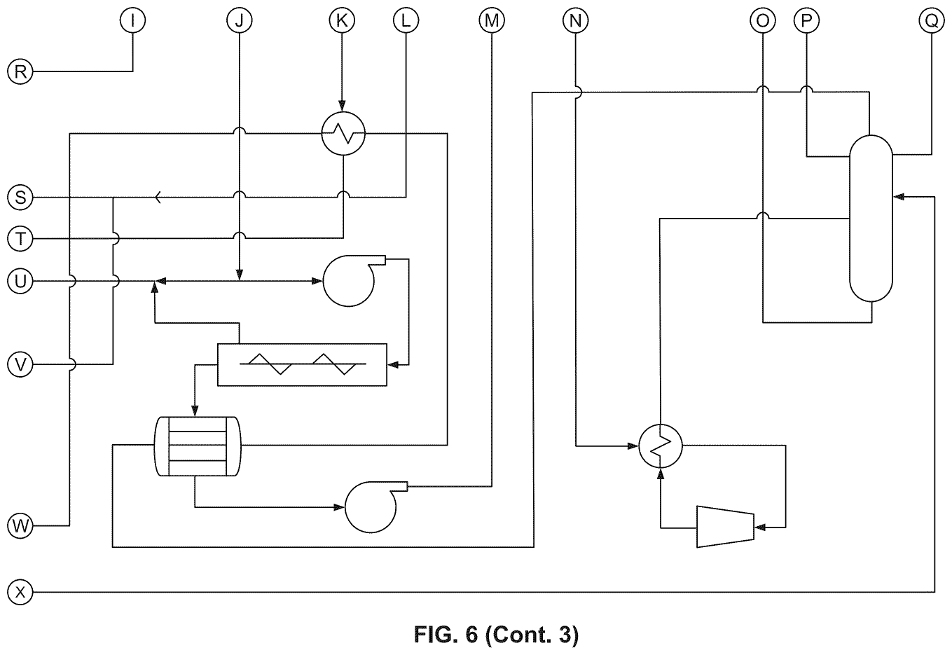

In an alternative embodiment of the system and method of the disclosure presented in FIG. 6, LNG cooling is not provided in the system pre-cool heat exchanger 302 (which takes the place of pre-cool heat exchanger 134 of FIG. 5). Instead, the dried process gas stream 118 exiting the desiccant dryer 116 is cooled in the pre-cool heat exchanger 302 solely by a clean light gas stream 304 from the desublimating heat exchanger 140. More specifically, in the embodiment of FIG. 6, clean light gas stream 146 exits the top of the heat exchanger 140 and is warmed in heater 306. The resulting stream 304 then is directed to, and provides cooling within, the pre-cool heat exchanger 302 prior to exiting as further warmed stream 308.

Clean light gas stream 308 is split to form streams 310 and 312. Stream 310 is warmed in heater 149 and then directed to desiccant dryer 116, as in the system of FIG. 5. Stream 312 is directed to cooling water cooling tower 126 to provide cooling therein.

The system of FIG. 6 also differs from the system of FIG. 5 in that only a single contact liquid cooling heat exchanger 150, which receives LNG stream 232 to provide cooling, is included in the cooling loop that receives slurry from slurry pump 145 and cooled contact liquid stream 204 from the product heat exchanger 170. The contact liquid cooling heat exchanger 152 of FIG. 5 has been omitted.

Other than the above exceptions, the system of FIG. 6 is identical to the system in FIG. 5.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A system for separating carbon dioxide from a process gas comprising:
a. a pre-cool heat exchanger configured to receive and cool a process gas stream so that a cooled process gas stream is formed;
b. a desublimating heat exchanger including a process gas inlet configured to receive the cooled process gas stream from the pre-cool heat exchanger, said desublimating heat exchanger further including a clean gas outlet, a contact liquid inlet and a slurry outlet;
c. a contact liquid heat exchanger in fluid communication with the contact liquid inlet of the desublimating heat exchanger and configured to receive and warm a liquid natural gas stream to provide cooling within the contact liquid heat exchanger;
d. said desublimating heat exchanger configured to contact the cooled process gas stream received from the pre-cool heat exchanger with contact liquid cooled by the contact liquid heat exchanger so that carbon dioxide is absorbed within the contact liquid whereby a carbon dioxide laden slurry stream and a carbon dioxide depleted clean process gas stream are formed with the clean process gas stream directed through the clean gas outlet to the pre-cool heat exchanger and the slurry stream directed through the slurry outlet;
e. said pre-cool heat exchanger configured to warm the clean process gas stream to provide cooling for the process gas stream;
f. a solid separation device in fluid communication with the contact inlet of the desublimating heat exchanger and configured to receive the carbon dioxide laden slurry stream from the slurry outlet of the desublimating heat exchanger and to separate the slurry stream into a condensed carbon dioxide stream and a contact liquid stream.

2. The system of claim 1 wherein the solid separation device is configured to direct the contact liquid stream to the contact liquid heat exchanger, and said contact liquid heat exchanger is configured to cool the contact liquid stream by warming the liquid natural gas stream.

3. The system of claim 1 wherein the contact liquid heat exchanger is configured to receive slurry the slurry stream from the slurry outlet of the desublimating heat exchanger, to cool the slurry stream by warming the liquid natural gas stream and to direct the cooled slurry stream to the solid separation device.

4. The system of claim 1 further comprising a liquid natural gas heater configured to receive a natural gas stream or a partially vaporized liquid natural gas stream from the contact liquid heat exchanger.

5. The system of claim 4 further comprising a liquid natural gas expansion device configured to receive warmed fluid from the liquid natural gas heater.

6. The system of claim 1 further comprising a liquid natural gas expansion device configured to receive a natural gas stream or a partially vaporized liquid natural gas stream from the contact liquid heat exchanger.

7. The system of claim 1 further comprising a source of liquid natural gas in fluid communication with the contact liquid heat exchanger.

8. The system of claim 7 further comprising a liquid natural gas pump configured to direct liquid natural gas from the source of liquid natural gas to the contact liquid heat exchanger.

9. The system of claim 7 further comprising an upstream liquid natural gas heater configured to warm liquid natural gas at it is transferred from the source of liquid natural gas to the contact heat exchanger.

10. The system of claim 1 wherein the contact liquid heat exchanger includes a first contact liquid heat exchanger and a second contact liquid heat exchanger.

11. The system of claim 10 wherein the first contact liquid heat exchanger is upstream from the second contact liquid heat exchanger and the first contact heat exchanger include ceramic insulation configured to insulate contact liquid from liquid natural gas.

12. The system of claim 1 wherein the pre-cool heat exchanger is also configured to receive and warm a liquid natural gas stream to provide cooling for the process gas stream.

13. The system of claim 12 wherein the contact liquid heat exchanger and the pre-cool heat exchanger receive liquid natural gas streams from a shared source.

14. A system for separating carbon dioxide from a process gas comprising:
a. a pre-cool heat exchanger configured to receive and cool a process gas stream so that a cooled process gas stream is formed;
b. a desublimating heat exchanger including a process gas inlet configured to receive the cooled process gas stream from the pre-cool heat exchanger, said desublimating heat exchanger further including a clean gas outlet, a contact liquid inlet and a slurry outlet;
c. a contact liquid heat exchanger;
d. a solid separation device configured to direct a contact liquid to the contact liquid inlet of the desublimating heat exchanger;
e. said desublimating heat exchanger configured to contact the cooled process gas stream received from the pre-cool heat exchanger with contact liquid from the solid separation device so that carbon dioxide is absorbed within the contact liquid whereby a carbon dioxide laden slurry stream and a carbon dioxide depleted clean process gas stream are formed with the clean process gas stream directed through the clean gas outlet to the pre-cool heat exchanger and the slurry stream directed through the slurry outlet to the contact liquid heat exchanger;
f. said pre-cool heat exchanger configured to warm the clean process gas stream to provide cooling for the process gas stream;
g. said contact liquid heat exchanger configured to receive and warm a liquid natural gas stream to cool the slurry stream, said contact liquid heat exchanger also configured to direct the cooled slurry stream to the solid separation device;
h. said solid separation device configured to separate the carbon dioxide laden slurry stream into a condensed carbon dioxide stream and a contact liquid stream.

15. The system of claim 14 wherein the pre-cool heat exchanger is also configured to receive and warm a liquid natural gas stream to provide cooling for the process gas stream.

16. The system of claim 15 wherein the contact liquid heat exchanger and the pre-cool heat exchanger receive liquid natural gas streams from a shared source.

17. The system of claim 14 wherein the separation device is a screw press.

18. The system of claim 14 further comprising a product heat exchanger in fluid communication with the solid separation device and configured to receive a carbon dioxide stream, said product heat exchanger also configured to receive and warm a liquid natural gas stream to cool the received carbon dioxide stream.

19. The system of claim 18 further comprising a melter configured to receive and melt a solid carbon dioxide stream from the solid separation device and to direct a resulting carbon dioxide liquid stream to the product heat exchanger.

20. A method for separating carbon dioxide from a process gas comprising:
a. pre-cooling a process gas stream by warming a clean process gas stream so that a cooled process gas stream is formed;
b. cooling a contact liquid by warming a liquid natural gas stream so that a cooled contact liquid stream is formed;
c. contacting the cooled process gas stream with the cooled contact liquid stream so that carbon dioxide is absorbed within the contact liquid whereby a carbon dioxide laden slurry stream and a carbon dioxide depleted clean process gas stream are formed, where the clean process gas stream is warmed in step a.;
d. separating the slurry stream into a condensed carbon dioxide stream and a contact liquid stream.

21. The method of claim 20 wherein the contact liquid stream of step d. is cooled in step b.

22. The method of claim 20 wherein step a. includes warming a liquid natural gas stream.

23. The method of claim 22 wherein the liquid natural gas streams of steps a. and b. are from a shard source.

24. The method of claim 20 wherein step b. includes cooling the slurry stream of step c.
